(19) United States
(12) Patent Application Publication
(10) Pub. No.: US 2001/0039587 A1
(43) Pub. Date: Nov. 8, 2001

(54) METHOD AND APPARATUS FOR ACCESSING DEVICES ON A NETWORK

(76) Inventors: STEPHEN UHLER, PALO ALTO, CA (US); RINALDO DIGIORGIO, EASTON, CT (US); MICHAEL BENDER, BOULDER CREEK, CA (US)

Correspondence Address: THE HECKER LAW GROUP, 1925 CENTURY PARK EAST, SUITE 2300, LOS ANGELES, CA, 90067, US

(21) Appl. No.: 09/177,876

(22) Filed: Oct. 23, 1998

(51) Int. Cl. G06F 15/16

(52) U.S. Cl. 709/229; 709/203

(57) ABSTRACT

A method and apparatus for accessing devices on a network. A URL (Uniform Resource Locator) is utilized on the internet to specify the application protocol (e.g., http), the domain name (e.g., www.sun.com), and file location (e.g., /users/hcn/index.html). One or more embodiments of the invention provide for accessing devices on a network and the internet by utilizing the URL and HTTP. By specifying the desired device action in the URL, it is unnecessary to create a plug-in or modify the browser for the resource. Each device or resource is connected to the network and is configured with a small amount of computer code that identifies the relevant commands that may be used to control the device. Additionally, the resource is configured to operate upon receiving the specified commands in the URL address that identifies the resource.

### BACKGROUND OF THE INVENTION

1. FIELD OF THE INVENTION

This invention relates to the field of computer networks and network devices, and, more specifically, to accessing devices on a network.

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever. Sun, Sun Microsystems, the Sun logo, Solaris, Java, JavaOS, JavaStation, Hotfava Views, JINI, JavaSpaces, Java RMI and all Java-based trademarks and logos are trademarks or registered trademarks of Sun Microsystems, Inc. in the United States and other countries.

2. BACKGROUND ART

In a diverse network, various devices and resources, such as printers, scanners, alarm systems, kitchen appliances, pool heaters, etc. may be accessible and may be operated by a user (client) or other device on the network. Existing schemes for accessing network devices are complex and require multiple layers of software to cooperate. These problems can be understood by reviewing networks and how they work.

A. Networks

In modern computing environments, it is commonplace to employ multiple computers or workstations linked together in a network to communicate between, and share data with network users. A network also may include resources, such as printers, modems, file servers, etc., and services, such as electronic mail. Additionally, networks may include household appliances such as a coffee maker, video cassette recorder (VCR), answering machine, or any type of electronic device (e.g., a digital camera, a camcorder, pool heater, light switch, etc.). Accessing and controlling these resources and devices on a network may be a difficult and time consuming task.

A network can be a small system that is physically connected by cables or via wireless communication (a local area network or “LAN”), or several separate networks can be connected together to form a larger network (a wide area network or “WAN”). Other types of networks include the internet, telcom networks, the World Wide Web, intranets, extranets, wireless networks, and other networks over which electronic, digital, and/or analog data may be communicated.

Computer systems sometimes rely on a server computer system to provide information to requesting computers on a network. When there are a large number of requesting computers, it may be necessary to have more than one server computer system to handle the requests.

The Internet is a worldwide network of interconnected computers. The internet may also include interconnected devices or resources as described above. An Internet user (referred to as a client) accesses the internet via an Internet provider. An Internet provider is an organization that provides a client (e.g., an individual or other organization) with access to the Internet (via analog telephone line or Integrated Services Digital Network line, for example). A client can, for example, download a file from or send an electronic mail message to another computer/client using the Internet. Additionally, a client can access and control a resource or device that is accessible via the internet. An Intranet is an internal corporate or organizational network that uses many of the same communications protocols as the Internet. The terms Internet, World Wide Web (WWW), and Web as used herein includes the Intranet as well as the Internet.

Instead of transmitting the information from the server that maintains the information, some systems utilize what is referred to as a proxy. A proxy is a server that carries out requests transmitted to it (i.e., from a client), keeping copies of fetched documents or information for some time so that they can be accessed more quickly in the future, speeding up access for commonly requested information. This maintaining of information and fetched documents by the proxy is referred to as caching and the information maintained in the proxy is referred to as a cache or proxy cache.

To protect information in internal computer networks from external access, a firewall is utilized. A firewall is a mechanism that blocks access between the client and the server. To provide limited access to information, a proxy or proxy server may sit atop a firewall and act as a conduit, providing a specific connection for each network connection. Proxy software retains the ability to communicate with external sources, yet is trusted to communicate with the internal network. For example, proxy software may require a username and password to access certain sections of the internal network and completely block other sections from any external access.

The components of the WWW include browser software, network links, and servers. The browser software, or browser, is a user-friendly interface (i.e., front-end) that simplifies access to the Internet. A browser allows a client to communicate a request without having to learn a complicated command syntax, for example. A browser typically provides a graphical user interface (GUI) for displaying information and receiving input. Examples of browsers currently available include Netscape Navigator and Internet Explorer.

Based on the type of information or resource that is being accessed, a browser may need additional functionality. For example, a video and sound clip file may require the capability to view the video and sound clip in a certain format. The prior art requires that the added capability be installed in the web browser. Commonly, the added capabilities are added onto the web browser and are referred to as “plug-ins”. Thus, whenever additional capability is needed, a plug-in must be downloaded (retrieved) and installed or added onto the client's web browser.

The number of devices and resources that may be connected to a network are limitless and each device or resource may require a plug-in for the browser to control and access the individual device or resource. Consequently, the access, operation, and control of a device or resource requires the difficult and time consuming task of plug-in creation, download, and installation.

B. Network Communication/Data Transfer

Information servers maintain the information on the WWW and are capable of processing a client request. To enable the computers on a network including the WWW to communicate with each other, a set of standardized rules for exchanging the information between the computers, referred to as a “protocol”, is utilized. Transfer Protocols generally specify the data format, timing, sequencing, and error checking of data transmissions. Numerous transfer protocols are used in the networking environment. For example, one family of transfer protocols is referred to as the transmission control protocol/internet protocol (“TCP/IP”). The TCP/IP family of transfer protocols is the set of transfer protocols used on the internet and on many multiplatform networks.

1. Transfer Protocols

The TCP/IP transfer protocol family is made up of numerous individual protocols (e.g., file transfer protocol (“FTP”), transmission control protocol (“TCP”), and network terminal protocol (“TELNET”)). The TCP protocol is responsible for breaking up a message to be transmitted into datagrams of manageable size, reassembling the datagrams at the receiving end, resending any datagrams that get lost (or are not transferred), and reordering the data (from the datagrams) in the appropriate order. A datagram is a unit of data or information (also referred to as a packet) that is transferred or passed across the internet. A datagram contains a source and destination address along with the data. The TCP transfer protocol is often utilized to transmit large amounts of information because of its ability to break up the information into datagrams and reassemble the information at the receiving end.

Another transfer protocol that is utilized to control the transfer of information is the user datagram protocol (“UDP”). UDP is designed for applications and data transmissions where sequences of datagrams do not need to be reassembled at the receiving end. UDP does not keep track of what has been transmitted in order to resend a datagram if necessary. Additionally, UDP's header information (information regarding the source and destination and other relevant information) is shorter than the header information utilized in TCP.

2. Application Protocols

To utilize a Transfer Protocol to transfer information, an Application Protocol that defines a set of commands which one machine sends to another is utilized (e.g., commands to specify who the sender of the message is, who it is being sent to, and the text of the message). The Transfer Protocol (e.g., TCP or UDP) is utilized to ensure that the Application Protocol commands are completely transmitted to the receiving end. HyperText Transfer Protocol (HTTP) is the standard application protocol for communication with an information server on the WWW. HTTP has communication methods that allow clients to request data from a server and send information to the server.

To submit a request, the client contacts the HTTP server and transmits the request to the HTTP server. The request contains the communication method requested for the transaction (e.g., GET an object from the server or POST data to an object on the server). The HTTP server responds to the client by sending a status of the request and the requested information. The connection is then terminated between the client and the HTTP server.

A client request therefore, consists of establishing a connection between the client and the HTTP server, performing the request, and terminating the connection. The HTTP server does not need to maintain any state about the connection once it has been terminated. HTTP is, therefore, a stateless application protocol. That is, a client can make several requests of an HTTP server, but each individual request is treated independent of any other request. The server has no recollection of any previous request. The server does not need to retain state from a prior request.

C. Addressing Scheme and Client/Server Data Retrieval

A browser displays information to a client/user as pages or documents (referred to as “web pages” or “web sites”). A language is used to define the format for a page to be displayed in the WWW. The language is called Hypertext Markup Language (HTML). A WWW page is transmitted to a client as an HTML document. The browser executing at the client parses the document and displays a page based on the information in the HTML document.

An addressing scheme is employed to identify Internet resources (e.g., HTTP server, file or program) and the file or HTML document to display. This addressing scheme is called Uniform Resource Locator (URL). A URL may contain the application protocol to use when accessing the server (e.g., HTTP), the Internet domain name (also referred to as the server host name) of the site on which the server is running, the port number of the server (the port number may not be specified in the URL but is obtained by translating the server host name), and the location of the resource in the file structure of the server. For example, the URL “http://www.sunlabs.com/research/hsn/index.html” specifies the application protocol (“http”), the server host name (“www.sunlabs.com”), and the filename to be retrieved (“/research/hsn/index.html”).

If the client request is for a file, the HTTP server locates the file and sends it to the client. An HTTP server also has the ability to delegate work to Common Gateway Interface (CGI) programs. The CGI specification defines the mechanisms by which HTTP servers communicate with gateway programs. A gateway program is referenced using a URL. The HTTP server activates the program specified in the URL and uses CGI mechanisms to pass program data sent by the client to the gateway program. Data is passed from the server to the gateway program via command-line arguments, standard input, or environment variables. The gateway program processes the data, generates an HTML document, and returns the HTML document as its response to the server using CGI (via standard input, for example). The server forwards the HTML document to the client using the HTTP.

Once files have been retrieved, the client may utilize or process the file. For example, if a HTML document is retrieved, a client's web browser may parse the HTML document and display the document. Depending on the type of file retrieved, the client may activate an application to process the file. For example, if a word processing document is retrieved, the client may activate a word processor to process the document. Alternatively, if an image file is retrieved, an image viewer may be activated to process and display the image.

Upon receiving a file, the client browser will typically examine the extension to determine how to process the file after receipt (e.g., launch an application program to process the file). As described above, the file processing may consist of launching an application that has been installed as a plug-in on the browser.

Customizing every browser with the capabilities to control and access a device or resource is time consuming for the resource owner (who has to create a plug-in for each browser that may be used), for the user (who has to download and install the plug-in causing a delay in utilizing the desired device), and for other internet or network users (due to the bandwidth that is utilized for the download of the plug-in).

### SUMMARY OF THE INVENTION

A method and apparatus for accessing devices on a network. A URL (Uniform Resource Locator) is utilized on the internet to specify the application protocol (e.g., http), the domain name (e.g., www.sun.com), and file location (e.g., /users/hcn/index.html).

One or more embodiments of the invention provide for accessing devices on a network and the internet by utilizing the URL and HTTP. By specifying the desired device action in the URL, it is unnecessary to create a plug-in or modify the browser for the resource. Each device or resource is connected to the network and is configured with a small amount of computer code that identifies the relevant commands that may be used to control the device. Additionally, the resource is configured to operate upon receiving the specified commands in the URL address that identifies the resource.

### BRIEF DESCRIPTION OF THE DRAWINGS

FIG. 1 is a block diagram of one embodiment of a computer system capable of providing a suitable execution environment for one or more embodiments of the invention.

FIG. 2 demonstrates a network and devices connected to a network in accordance with one or more embodiments of the invention.

FIG. 3 illustrates the execution flow of a method for accessing a device on a network in accordance with one or more embodiments of the invention.

FIG. 4 illustrates the execution flow of a method for authenticating a user using smart cards in accordance with one or more embodiments of the invention.

### DETAILED DESCRIPTION OF THE INVENTION

The invention is a method and apparatus for accessing devices on a network. In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

Embodiment of Computer Execution Environment (Hardware)

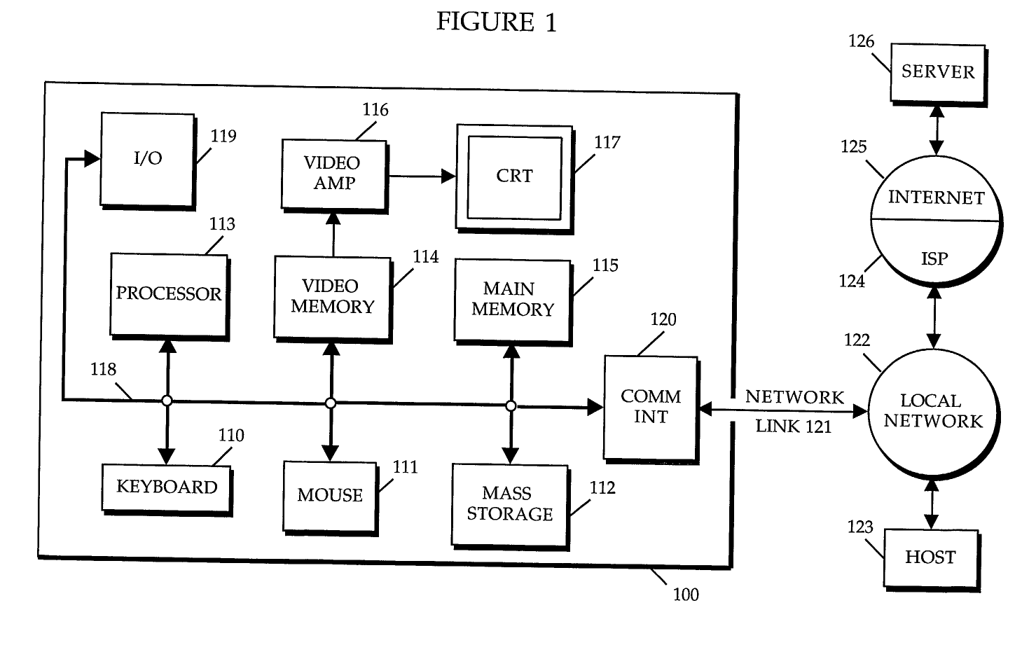

An embodiment of the invention can be implemented as computer software in the form of computer readable code executed on a general purpose computer such as computer 100 illustrated in FIG. 1, or in the form of bytecode class files running on such a computer. A keyboard 110 and mouse 111 are coupled to a bidirectional system bus 118. The keyboard and mouse are for introducing user input to the computer system and communicating that user input to processor 113. Other suitable input devices may be used in addition to, or in place of, the mouse 111 and keyboard 110. I/O (input/output) unit 119 coupled to bidirectional system bus 118 represents such I/O elements as a printer, A/V (audio/video) I/O, household appliance, light switches, other electronic devices, etc.

Computer 100 includes a video memory 114, main memory 115 and mass storage 112, all coupled to bidirectional system bus 118 along with keyboard 110, mouse 111 and processor 113. The mass storage 112 may include both fixed and removable media, such as magnetic, optical or magnetic optical storage systems or any other available mass storage technology. Bus 118 may contain, for example, thirty-two address lines for addressing video memory 114 or main memory 115. The system bus 118 also includes, for example, a 32-bit data bus for transferring data between and among the components, such as processor 113, main memory 115, video memory 114 and mass storage 112. Alternatively, multiplex data/address lines may be used instead of separate data and address lines.

In one embodiment of the invention, the processor 113 is a microprocessor manufactured by Motorola, such as the 680×0 processor or a microprocessor manufactured by Intel, such as the 80×86, or Pentium processor, or a SPARC microprocessor from Sun Microsystems, Inc. However, any other suitable microprocessor or microcomputer may be utilized. Main memory 115 is comprised of dynamic random access memory (DRAM). Video memory 114 is a dual-ported video random access memory. One port of the video memory 114 is coupled to video amplifier 116. The video amplifier 116 is used to drive the cathode ray tube (CRT) raster monitor 117. Video amplifier 116 is well known in the art and may be implemented by any suitable apparatus. This circuitry converts pixel data stored in video memory 114 to a raster signal suitable for use by monitor 117. Monitor 117 is a type of monitor suitable for displaying graphic images.

Computer 100 may also include a communication interface 120 coupled to bus 118. Communication interface 120 provides a two-way data communication coupling via a network link 121 to a local network 122. For example, if communication interface 120 is an integrated services digital network (ISDN) card or a modem, communication interface 120 provides a data communication connection to the corresponding type of telephone line, which comprises part of network link 121. If communication interface 120 is a local area network (LAN) card, communication interface 120 provides a data communication connection via network link 121 to a compatible LAN. Wireless links are also possible. In any such implementation, communication interface 120 sends and receives electrical, electromagnetic or optical signals which carry digital data streams representing various types of information.

Network link 121 typically provides data communication through one or more networks to other data devices. For example, network link 121 may provide a connection through local network 122 to local server computer 123 or to data equipment operated by an Internet Service Provider (ISP) 124. Alternatively, devices connected to the network may be configured with a network communication unit that enables the devices to communicate across network link 121. 1SP 124 in turn provides data communication services through the world wide packet data communication network now commonly referred to as the “Internet” 125. Local network 122 and Internet 125 both use electrical, electromagnetic or optical signals which carry digital data streams. The signals through the various networks and the signals on network link 121 and through communication interface 120, which carry the digital data to and from computer 100, are exemplary forms of carrier waves transporting the information.

Computer 100 can send messages and receive data, including program code, through the network(s), network link 121, and communication interface 120. In the Internet example, remote server computer 126 might transmit a requested code for an application program through Internet 125, ISP 124, local network 122 and communication interface 120. In accord with the invention, one such application is that of accessing a device on a network.

The received code may be executed by processor 113 as it is received, and/or stored in mass storage 112, or other non-volatile storage for later execution. In this manner, computer 100 may obtain application code in the form of a carrier wave.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment.

Utilization of Computer Software

Devices, clients, and servers may contain multiple related functions and data structures. One embodiment of the invention utilizes a standard object oriented programming (OOP) language to write and encapsulate an application's transactions, functions, and data structures. To provide an understanding of encapsulation of related data structures and methods, an overview of object-oriented programming is provided below.

Object-Oriented Programming

Object-oriented programming is a method of creating computer programs by combining certain fundamental building blocks, and creating relationships among and between the building blocks. The building blocks in object-oriented programming systems are called “objects.” An object is a programming unit that groups together a data structure (one or more instance variables) and the operations (methods) that can use or affect that data. Thus, an object consists of data and one or more operations or procedures that can be performed on that data. The joining of data and operations into a unitary building block is called “encapsulation.”

An object can be instructed to perform one of its methods when it receives a “message.” A message is a command or instruction sent to the object to execute a certain method. A message consists of a method selection (e.g., method name) and a plurality of arguments. A message tells the receiving object what operations to perform.

One advantage of object-oriented programming is the way in which methods are invoked. When a message is sent to an object, it is not necessary for the message to instruct the object how to perform a certain method. It is only necessary to request that the object execute the method. This greatly simplifies program development.

Object-oriented programming languages are predominantly based on a “class” scheme. The class-based object-oriented programming scheme is generally described in Lieberman, “Using Prototypical Objects to Implement Shared Behavior in Object-Oriented Systems,” OOPSLA 86 Proceedings, September 1986, pp. 214-223.

A class defines a type of object that typically includes both variables and methods for the class. An object class is used to create a particular instance of an object. An instance of an object class includes the variables and methods defined for the class. Multiple instances of the same class can be created from an object class. Each instance that is created from the object class is said to be of the same type or class.

To illustrate, an employee object class can include “name” and “salary” instance variables and a “set_salary” method. Instances of the employee object class can be created, or instantiated for each employee in an organization. Each object instance is said to be of type “employee.” Each employee object instance includes “name” and “salary” instance variables and the “set_salary” method. The values associated with the “name” and “salary” variables in each employee object instance contain the name and salary of an employee in the organization. A message can be sent to an employee's employee object instance to invoke the “set_salary” method to modify the employee's salary (i.e., the value associated with the “salary” variable in the employee's employee object).

A hierarchy of classes can be defined such that an object class definition has one or more subclasses. A subclass inherits its parent's (and grandparent's etc.) definition. Each subclass in the hierarchy may add to or modify the behavior specified by its parent class. Some object-oriented programming languages support multiple inheritance where a subclass may inherit a class definition from more than one parent class. Other programming languages support only single inheritance, where a subclass is limited to inheriting the class definition of only one parent class.

A developer may desire to have different implementations of a common method in each subclass. For example, suppose that a class A defines a method for printing a file horizontally (e.g., in landscape view) and that a class B defines a method for printing a file vertically (e.g., in portrait view). Instead of providing for the same method in each class (with the only difference being the orientation with which the file is printed), Java permits the developer to define an interface implemented by both class A and class B that prints a file. A class definition of the interface accepts instances of class A or class B as arguments to produce the desired result. Consequently, each class declares to implement the interface and creates their own implementation of the method. At run time, reference to the commonly implemented method is resolved. An interface also provides the functions the developer must define in order for future developers and users to communicate with specific instances of an object.

An object is a generic term that is used in the object-oriented programming environment to refer to a module that contains related code and variables. A software application can be written using an object-oriented programming language whereby the program's functionality is implemented using objects. The encapsulation provided by objects in an object-oriented programming environment may be extended to the notion of devices, clients, and servers as described below.

Embodiment of Software Apparatus for Accessing Devices on a Network

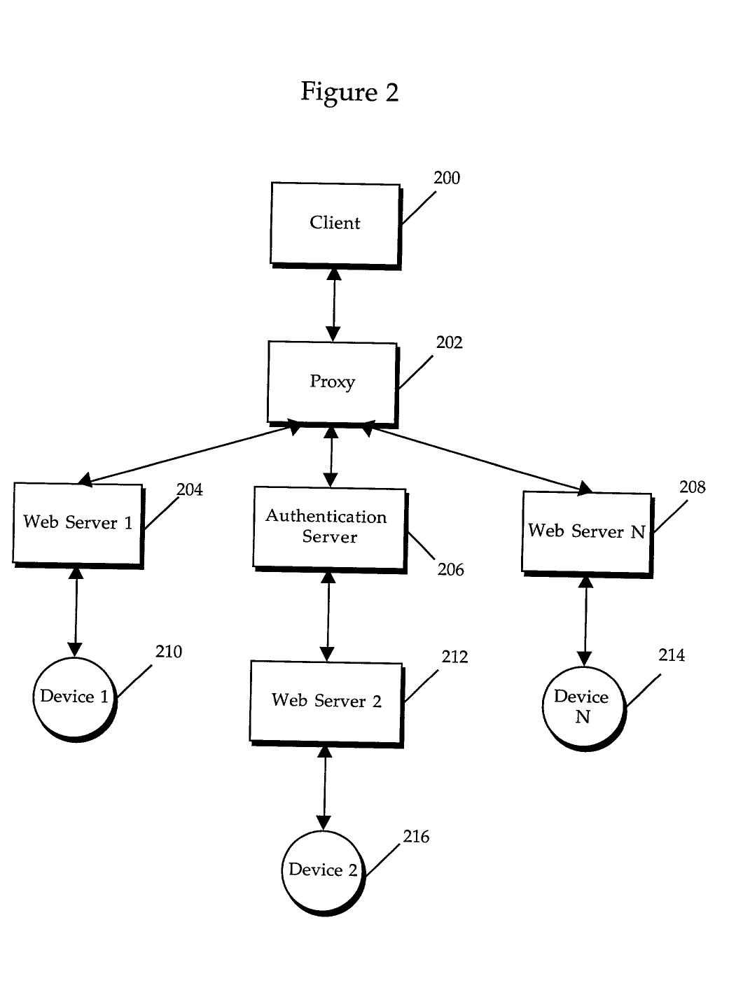

In one or more embodiments of the invention, devices and resources are accessible by a browser using HTTP and URL requests. FIG. 2 demonstrates a network according to one ore more embodiments of the invention. Client 200 communicates with an internet service provider (e.g., by requesting a web page or device operation), or a proxy 202. Proxy 202 forwards client 200's request to a web server such as web server 1 204 or web server N 208. Alternatively, proxy 202 may communicate with an authentication server 206. Authentication server 206 verifies or authenticates the identity and authorization of client 200. For example, authentication server 206 may decrypt client 200's request or may request client 200 submit a username and password which is then verified by cross checking the submitted information or by an alternative method.

Once client 200 or the request of client 200 has been authenticated, authentication server 206 may forward the request to web server 212. Web server 1 204, web server 2 212, and web server N 208 may each be responsible for transmitting a web page (e.g., an HTML document) or may be responsible for a device (as described above) such as device 1 210, device 2 216, or device N 214. If responsible for a device (which is configured with a network communication unit), the relevant web server may issue the appropriate command/request to the device and may wait for a result. For example, if device 1 210 is a light switch, web server 1 204 may issue a command to device 1 210 to turn off the light. In response, device 1 210 would turn off the light, and may return an acknowledged command to web server 1 204. The acknowledged command may then be propagated through the internet back to client 200. In another embodiment, authentication server 206 would confirm that client 200 has the appropriate authorization to turn off the light at device 2 216 (to prevent unauthorized users from turning off the lights). Once authorized, web server 2 212 would issue the appropriate command to device 2 216. Alternatively, web server 2 212 may be an integrated part of device 2 216 such as a semiconductor device that is configured to accept and operate device 2 216.

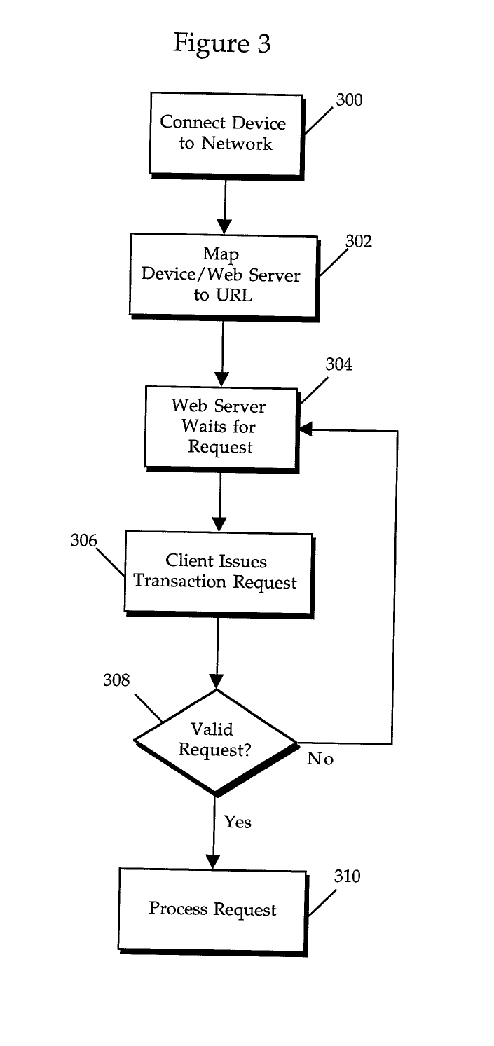

FIG. 3 illustrates the operation of a device in accordance with one or more embodiments of the invention. At step 300, the device is connected to a network. At step 302, the device and its associated web server (the web server may be part of the device) is mapped to a URL. At step 304, the web server waits for a request from the client. At step 306, the client issues a request to operate the device. For example, the client may desire to turn on the pool heater, turn on the air conditioning unit, or set the video cassette recorder (VCR) to record a television program (all of which may be devices connected to the network at step 300 and mapped to individual URLs at step 302). If necessary, the client or the client request may be authenticated/validated at step 308. The authentication may be performed by a authentication server as described above. If valid, the web server and device processes the request at step 310.

Specific Embodiments

As described above, any device that may be interfaced to a computer (e.g., scanners, sensors, data recording equipment, etc.) can be utilized according to one or more embodiments of the invention. For example, according to one or more embodiments, an interface entitled HTTPAccessibleDevice may be defined which is implemented by each device that requires access via HTTP.

Scanner

According to one or more embodiments of the invention, a scanner may be utilized and accessed using HTTP. Referring to FIG. 3, at step 300, the scanner is connected to the network. To access a scanner using HTTP, a machine on the network may implement the HTTPAccessibleDevice interface for a scanner as HTTPScannerServer, for example. The HTTPScannerServer implementation understands a command to scan. Accordingly, at step 302, the HTTPScannerServer is implemented and defines the appropriate URL that the scanner is mapped to. The HTTPScannerServer waits for a request at step 304. The HTTPScannerServer may wait for the request at a commonly used port such as port 80 or an alternative port that may be defined. At step 306 the client browser issues a request to scan the document in the scanner, for example. At step 308, the server determines if the request is valid and checks the scanner for the presence of something to scan. If there is nothing in the scanner or the request is invalid (e.g., not requested by an authorized client), an error (e.g., HTTPD error) is returned to the client.

Once validated and the presence of something in the scanner is verified, the scan is started, and the data may be returned as a valid mime type at step 310. The requesting browser receives the response data and may display the scanned image.

Card Server

The CardServer is a web server such as an HTTPD (Hyper Text Transfer Protocol Daemon) server (an HTTPD server is a server that makes hypertext and other documents available to web browsers) that understands URLs in a specific format. Namely, a CardServer recognizes URLs of the form . . . /SecureTokenServices/GetId (i.e., URLs that end with “/SecureTokenServices/GetId”). A CardServer may be used as an authentication server as described above to authenticate a client or a client request. Additionally, a CardServer may provide the ability to utilize and access a Smart Card. A Smart Card is a card that has the ability to store information on an integrated microprocessor chip located within the card.

Two types of smart cards are commonly available: an intelligent smart card and a memory card. An intelligent smart card contains a central processing unit (CPU) providing the card with the ability to store and secure information, and “make decisions” as required by a card issuer's specific application needs. An intelligent smart card offers read/write capability such that monetary value can be added and decremented as required, for example. A memory card provides the ability to store information. For example, a memory card may contain a stored value that the user can “spend” in a pay phone, retail, vending, or related transaction.

The basic unit of communication with a smart card is called an APDU which stands for Application Protocol Data Unit as shown below. The following tables illustrate command and response APDU formats, respectively:

The mandatory header codes the selected command. It consists of four fields: class (CLA), instruction (INS), and parameters 1 and 2 (P1 and P2). Each field may contain 1 byte as follows:

CLA: Class byte. In many smart cards, this byte is used to identify an application.

INS: Instruction byte. This byte indicates the instruction code.

P1-P2: Parameter bytes. These provide further qualification to the APDU command.

Lc denotes the number of bytes in the data field of the command APDU.

Le denotes the maximum number of bytes expected in the data field of the following response APDU.

### Response APDU

### Conditional Body Mandatory Trailer

### Data field SW1 SW2

Status bytes SW1 and SW2 denote the processing status of the command APDU in a card.

In order to send APDU type commands to a smart card, one needs only create the packet and send it. The result may then be returned to the user as an HTML page and can be processed further in a Java applet/application.

Various interfaces and classes may be implemented to provide the smart card with the ability to determine the amount of money remaining on the card, to set the personal identification number (PIN) of the card, and to retrieve the card's identification information, etc. For example, a SecureTokenServiceHandler class may implement a handler for commands like Get the card id, tell me how much money there is on the card, set pin. etc. An implementation of the SecureTokenServiceHandler class may provide the desired functionality for a specific card or type of card. Thus, an application developer can implement the SecureTokenServiceHandler class and create a generic purse that works across a number of cards.

For example, the following three handlers may implement the SecureTokenServiceHandler class:

GenericAPDUHandler

MPCOSHandler

SecureTokenServiceHandler

Mondex Purse with Mondex Authentication

JavaCard ×OR authentication

JavaRing SmartCert authentication

The GenericAPDUHandler class provides the ability to command and retrieve responses for a smart card that utilizes the APDU format of communication. The MPCOSHandler class provides the ability to access card specific functions of the EMV family of smart cards. The SecureTokenServiceHandler class may provide a generic purse for a number of cards that works across several cards such as the Mondex Purse with Mondex Authentication, JavaCard ×OR authentication, or the JavaRing SmartCert authentication.

For example, web servers that are mapped to URLs using the above class implementations may provide the ability to utilize Mondex Cards, Java Cards running the Corporate Card Application, iButtons (iButtons are a mechanism used for authentication and auditing types of applications; iButtons can store data, have a clock for time-stamping, and the ability to support encryption and authentication) running the Java Card 2.0 api, and MPCOS-EMV cards (a type of smart card).

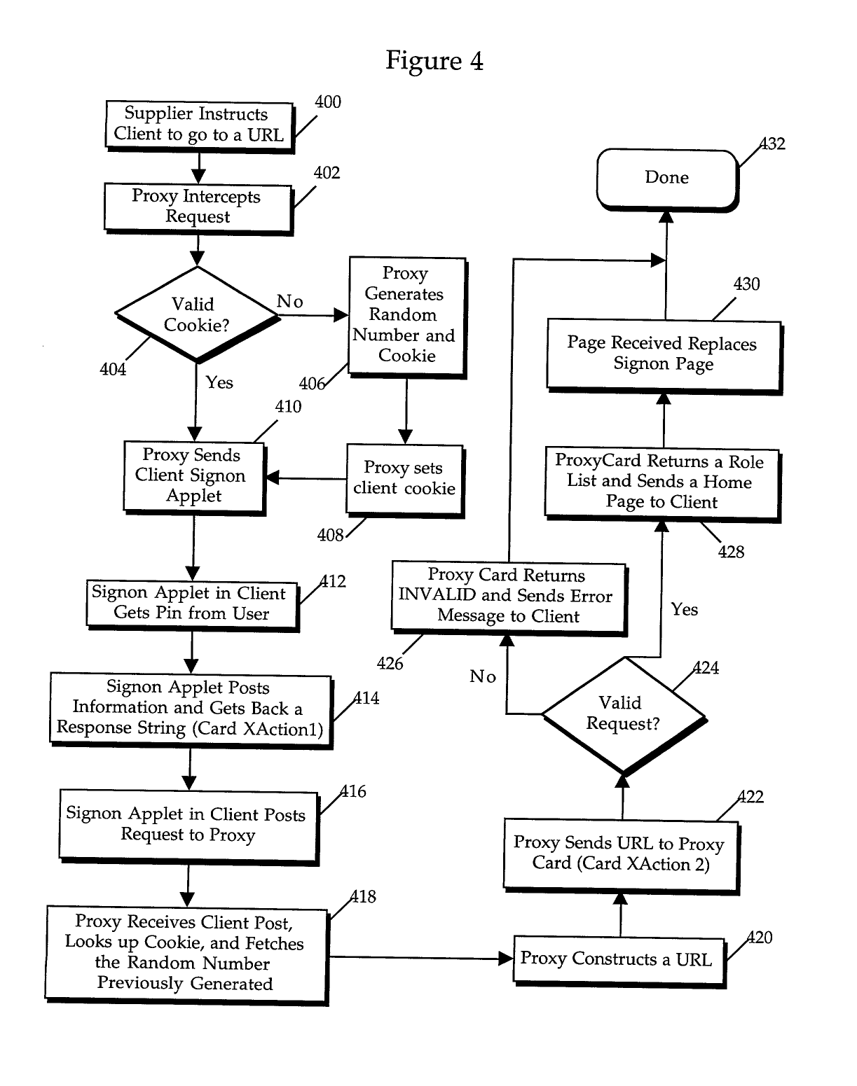

Using the classes as described above, many types of applications and protocols may be implemented. For example, FIG. 4 illustrates a sample authentication transaction protocol using mondex cards wherein a user is authenticated using a Mondex smart card prior to displaying a web page. In the example, a supplier refers to a person at a vendor location operating a client browser, a client refers to the browser being used by the supplier, the supplier card refers to the URLs that represent the supplier's card, the proxy refers to the fire-wall proxy server responsible for authentication, and the proxy card refers to the URLs (known to the proxy) that represent the proxy's card.

At step 400, the supplier instructs a client (browser) to go to a URL such as vendor.sun.com via a security sockets layer (SSL) (a SSL interfaces with HTTP to provide a web browser secure transactions by providing the ability to encrypt and decrypt data). At step 402, a proxy intercepts the request. At step 404 the proxy determines if the cookie transmitted by the client is a valid authentication cookie (cookies are small pieces of information that can later be read back from a browser; when a web site is accessed, a cookie is sent by the web site identifying itself to the web browser; cookies are stored by the browser and may be read back by any server that desires to access the cookies at a later date). Thus, the cookie transmitted by the client and is compared to a list of valid cookies to determine if the client has the proper authentication, for example. If the cookie is valid, the proxy forwards the request. If there is no cookie, the proxy generates a random number and a cookie (the cookie and random number could be the same) at step 406. Additionally, the proxy remembers the current connection “state” of the client. At step 408, the proxy sets the client's cookie with the generated cookie.

At step 410, the proxy sends the client a “signon” applet with the random number and client card URL as parameters. The signon applet provides the client with the ability receive a username or password or PIN from the supplier. At step 412, the signon applet obtains the PIN from the user. At step 414, the signon applet “posts” the PIN and any other relevant information and gets back a response string (referred to as a client card xaction). For example, the client may post the following HTTP command “http://localhost:????/CheckPin?”. At step 416, the signon applet then posts the information to the proxy. At step 418, the proxy receives the client post, looks up the “cookie” transmitted, and fetches or creates a random number (that may have been created at step 406. At step 420, the proxy constructs a URL to transmit which contains the random number and the response string received at step 414.

At step 422, the proxy sends the constructed URL to the proxy card (referred to as server card xaction). For example, the server card could transmit the following HTTP command: “http://servercard.eng:????/AuthenticatePin?”. In response to receiving the URL, the proxy card determines if the URL request is valid at step 424. If the request is invalid, the proxy card returns INVALID and an error message to the client at step 426. If the request is valid, the proxy sends a “role list” and sends a “home page” or web page to the client and remembers the client authorization roles at step 428. At step 430, the client replaces the signon web page with the page received from the proxy card. The process is complete at step 432.

Thus, in accordance with FIG. 4, smart cards (i.e., the proxy card and the supplier card) are accessed using URLs and HTTP to provide a method to authenticate a user (supplier). In addition to the above, additional URLs and HTTP requests may be useful to test and debug smart cards. For example, URL such as “http:// . . . /CheckPin?” may be utilized to perform a local card pin check to return OK/BAD. Additionally, the URL “http:// . . . /card_id” may be utilized to obtain the local card id.

Thus, a method and apparatus for accessing devices on a network is described in conjunction with one or more specific embodiments. The invention is defined by the claims and their full scope of equivalents.

1. A method for accessing a device on a network comprising:
connecting a device to a network; and
mapping said device to a URL;

2. The method of claim 1 wherein said device is a household appliance.

3. The method of claim 1 wherein said connecting step comprises:
installing a network communication unit in said device; and
connecting said device to a network by connecting said network communication device to a network.

4. The method of claim 1 wherein said device is connected to a web server.

5. The method of claim 1 further comprising:
waiting for a request;
determining if a request is valid;
processing said request if said request is valid.

6. The method of claim 1 wherein said device is a smart card.

7. The method of claim 5 wherein said determining step utilizes a smart card to authenticate a user.

8. A system comprising
a processor;
a memory coupled to said processor;
code executed by said processor configured to access a device on a network;
said code comprising:
a method connecting a device to a network; and
a method mapping said device to a URL;

9. The system of claim 8 wherein said device is a household appliance.

10. The system of claim 8 wherein said code comprising a method connecting comprises:
a method installing a network communication unit in said device; and
a method connecting said device to a network by connecting said network communication device to a network.

11. The system of claim 8 wherein said device is connected to a web server.

12. The system of claim 8, said code further comprising:
a method waiting for a request;
a method determining if a request is valid;
a method processing said request if said request is valid.

13. The system of claim 8 wherein said device is a smart card.

14. The system of claim 12 wherein said code comprising determining utilizes a smart card to authenticate a user.

15. A computer program product comprising
a computer usable medium having computer readable program code embodied therein configured to access a device on a network, said computer program product comprising:
computer readable code configured to cause a computer to connect a device to a network; and
computer readable code configured to cause a computer to map said device to a URL;

16. The computer program product of claim 15 wherein said device is a household appliance.

17. The computer program product of claim 15 wherein said computer readable code configured to cause a computer to connect comprises:
computer readable code configured to cause a computer to install a network communication unit in said device; and
computer readable code configured to cause a computer to connect said device to a network by connecting said network communication device to a network.

18. The computer program product of claim 15 wherein said device is connected to a web server.

19. The computer program product of claim 15 further comprising:
computer readable code configured to cause a computer to wait for a request;
computer readable code configured to cause a computer to determine if a request is valid;
computer readable code configured to cause a computer to process said request if said request is valid.

20. The computer program product of claim 15 wherein said device is a smart card.

21. The computer program product of claim 19 wherein said computer readable code configured to cause a computer to determine utilizes a smart card to authenticate a user.
